(19) United States
(12) Patent Application Publication
(10) Pub. No.: US 2011/0011337 A1
(43) Pub. Date: Jan. 20, 2011

(54) IMAGE FORMING APPARATUS

(75) Inventors: Il-ju MUN, Suwon-si (KR); Karp-sik Youn, Hwaseong-si (KR); Dong-woo Ha, Hwaseong-si (KR); In-su Lee, Seoul (KR); Young-choon Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/696,117

(22) Filed: Jan. 29, 2010

(30) Foreign Application Priority Data
Jul. 14, 2009 (KR) 10-2009-0063901

(51) Int. Cl. B05C 9/12; B05C 1/08

(52) U.S. Cl. 118/694; 118/46; 118/663

(57) ABSTRACT

An image forming apparatus including a medium feeding unit to supply a print medium, a medium coating assembly to coat the print medium with a coating liquid, and an image forming unit to form an image on the coated print medium, the medium coating assembly including a container to store the coating liquid, a coating unit to coat the print medium with the coating liquid, a channel to guide the coating liquid to move between the container and the coating unit, and a controller to selectively control the coating liquid to be supplied from the container to the coating unit and to be recovered from the coating unit to the container through the same channel.

### CROSS-REFERENCE TO RELATED APPLICATIONS

This application claims priority under 35 U.S.C. §119(a) from Korean Patent Application No. 10-2009-0063901, filed on Jul. 14, 2009 in the Korean Intellectual Property Office, the disclosure of which is incorporated herein by reference.

### BACKGROUND

1. Field of the Invention

The present general inventive concept relates to an image forming apparatus forming an image on a print medium, and more particularly, to an image forming apparatus having a structure of coating on a print medium in a stage previous to forming an image.

2. Description of the Related Art

An image forming apparatus employs various methods for forming an image on a print medium. For example, there are laser-printer type methods for forming a visual image with a developer on a photosensitive body having an electrostatic latent image and transferring it to a print medium, inkjet type methods of jetting ink on the print medium, etc.

In an inkjet image forming apparatus, the ink jetted to the print medium and forming an image permeates into the print medium since it is liquid, thereby deteriorating the definition of the image. Also, the print medium may be curled as the ink on the print medium is dried. To overcome these problems, there has been proposed a configuration of coating the print medium with a previously designated coating liquid in a stage prior to forming an image with the ink.

A conventional image forming apparatus includes a supplying channel and a recovering channel between a container storing a coating liquid and a coating roller, and drives a pump to make the coating liquid run through the supplying and recovering channels, thereby supplying the coating liquid to the coating roller and recovering the coating liquid from the coating roller.

However, in such a conventional image forming apparatus, a region where the coating liquid is supplied to and recovered from the coating roller has to be sealed airtight to suck the coating liquid, so that the pump can supply and recover the coating liquid. Thus, a sealing configuration is necessary to keep this region airtightly sealed. Further, the configuration becomes complicated since the channels are needed corresponding to the supply and the recovery, respectively.

Also, in the conventional image forming apparatus, if the speed of rotating the coating roller is varied depending on printing jobs, the amount of the coating liquid usable with the print medium is also varied. Thus, a coating level may not be uniform but varied depending on the print medium.

Additionally, the conventional image forming apparatus has a problem that the coating is usable with the print media loaded onto the existing loading tray. Thus, when a special print medium having no need of the coating is loaded onto the loading tray, unnecessary coating is performed, thus lowering the quality of a formed image. To solve this problem, there has been proposed a method of loading such a special print medium to a separate loading tray. However, this method causes the image forming apparatus to have a complicated configuration and is inconvenient for a user.

### SUMMARY

Embodiments of the present general inventive concept provide an image forming apparatus having a simple configuration instead of a complicated sealing configuration in order to achieve a structure for supplying and recovering a coating liquid with respect to a coating roller.

Additional features and utilities of the present general inventive concept will be set forth in part in the description which follows and, in part, will be obvious from the description, or may be learned by practice of the general inventive concept.

Embodiments of the present general inventive concept provide an image forming apparatus capable of applying a uniform coating level to a print medium even though a rotating speed of a coating roller changes.

Embodiments of the present general inventive concept provide an image forming apparatus capable of selectively distinguishing between a print media to be coated and a print media not to be coated among the print media loaded to one loading tray.

Embodiments of the present inventive concept can be achieved by providing a image forming apparatus including a medium feeding unit to supply a print medium, a medium coating assembly to coat the print medium with a coating liquid, and an image forming unit to form an image on the coated print medium, the medium coating assembly including a container to store the coating liquid, a coating unit to coat the print medium with the coating liquid, a channel to guide the coating liquid to move between the container and the coating unit, and a controller to selectively control the coating liquid to be supplied from the container to the coating unit and to be recovered from the coating unit to the container through the same channel.

The image forming apparatus may further include a pump to supply or recover the coating liquid through the channel, wherein the controller controls the pump to supply or recover the coating liquid according to whether the image forming unit forms an image.

The controller may control the pump to supply the coating liquid from the container via the channel when the image forming unit starts forming an image, and control the pump to recover the coating liquid to the container via the channel when the image forming unit completes forming an image.

The coating unit may include a supplying channel to accommodate the coating liquid to be supplied through the channel and a coating member to receive and apply the coating liquid from the supplying channel to the print medium.

The coating unit may further include a level sensor to sense a level of the coating liquid accommodated in the supplying channel.

The controller may control the pump to adjust the level of the coating liquid within a preset level range if determining that the level of the coating liquid sensed by the level sensor is beyond the preset level range.

The supplying channel and the coating member may be sealed, and the coating unit may further include an air vent provided in the supplying channel and adjusting pressure inside the supplying channel as the pump operates.

The medium coating assembly may further include a coating liquid regulating unit to regulate the coating liquid of the coating unit, to be usable with the print medium, and the controller may control a coating liquid regulation of the coating liquid regulating unit in response to a speed change in applying the coating liquid by the coating unit.

The coating unit may include a coating roller coming into contact with the print medium and applying the coating liquid to the print medium, and the coating liquid regulating unit may regulate the coating liquid on a surface of the coating roller.

The controller may control the coating liquid regulation in response to a speed change in rotating the coating roller.

The coating liquid regulating unit may include a supporting frame provided movably, a regulating member forming a nip together with the coating roller, and an elastic member supported by the supporting frame to elastically urge the regulating member against the coating roller and forming pressure to regulate the coating liquid in the nip.

The controller may adjust pressure in the nip formed between the coating roller and the regulating member by moving the supporting frame in response to rotating speed of the coating roller.

The controller may control the supporting frame to approach the coating roller by a preset distance as the rotating speed of the coating roller becomes faster, but to become apart from the coating roller by a preset distance as the rotating speed of the coating roller becomes slower.

The coating unit may further include a supplying channel accommodating the coating liquid to be supplied to the coating roller, and the coating liquid regulating unit includes a regulating member coupled to the supplying channel and forming a nip together with the coating roller, and an elastic member supported by the supporting frame to elastically urge the supplying channel to the coating roller and forming pressure to regulate the coating liquid in the nip.

The controller may adjust pressure in the nip formed between the coating roller and the regulating member by moving the supporting frame in response to rotating speed of the coating roller.

The controller may control the supporting frame to approach the coating roller by a preset distance as the rotating speed of the coating roller becomes faster, but to become apart from the coating roller by a preset distance as the rotating speed of the coating roller becomes slower.

The supplying channel and the coating roller may be sealed, and the coating unit may further include an air vent provided in the supplying channel and adjusting pressure inside the supplying channel as the pump operates.

The image forming apparatus may further include a path selecting unit to guide the print medium of the medium feeding unit to be transported along a first path or a second path.

The path selecting unit may include a guide movable between a first position where the print medium is guided to be transported along the first path and a second position where the print medium is guided to be transported along the second path.

The image forming apparatus may further include a user input unit for selecting one of the first path and the second path, wherein the controller controls the guide to move to one of the first position and the second position as selected through the user input unit.

### BRIEF DESCRIPTION OF THE DRAWINGS

The above and/or other features and utilities of the present general inventive concept will become apparent and more readily appreciated from the following description of the exemplary embodiments, taken in conjunction with the accompanying drawings, in which:

FIG. 1 is a lateral section view of a medium coating assembly of an image forming apparatus according to an exemplary embodiment of the present general inventive concept;

FIG. 2 is a perspective view of a level sensor in the medium coating assembly of FIG. 1;

FIG. 3 is a lateral section view of a medium coating assembly of an image forming apparatus according to another exemplary embodiment of the present general inventive concept;

FIG. 4 is a lateral section view showing an example of controlling a coating liquid regulation corresponding to a rotating speed of a coating roller in the medium coating assembly of FIG. 3;

FIG. 5 is a lateral section view of a medium coating assembly of an image forming apparatus according to another exemplary embodiment of the present general inventive concept;

FIG. 6 is a lateral section view of a medium coating assembly of an image forming apparatus according to another exemplary embodiment of the present general inventive concept;

FIG. 7 is a lateral section view showing a partial schematic configuration of an image forming apparatus according to another exemplary embodiment of the present general inventive concept;

FIG. 8 is a lateral section view showing a partial schematic configuration of an image forming apparatus according to another exemplary embodiment of the present general inventive concept;

FIG. 9 is a lateral section view of a medium coating assembly in an image forming apparatus according to another exemplary embodiment of the present general inventive concept; and

FIG. 10 is a lateral section view of a schematic configuration of an image forming apparatus according to another exemplary embodiment of the present general inventive concept.

### DETAILED DESCRIPTION OF THE EXEMPLARY EMBODIMENTS

Hereinafter, exemplary embodiments of the present inventive general concept will be described in detail with reference to accompanying drawings. First, the following description principles are applied to all exemplary embodiments to be described below. If one embodiment has the same element as a previous embodiment, description about this element may be omitted. Also, if elements are similar to each other with respect to their function or structure but different from each other, reference numerals may be given thereto differently according to exemplary embodiments or drawings. Further, the drawing may mainly show elements directly related to a corresponding exemplary embodiment and omit the other elements, but these elements are not practically excluded in realizing the present general inventive concept.

Reference will now be made in detail to the exemplary embodiments of the present general inventive concept, examples of which are illustrated in the accompanying drawings, wherein like reference numerals refer to the like elements throughout. The embodiments are described below in order to explain the present general inventive concept by referring to the figures.

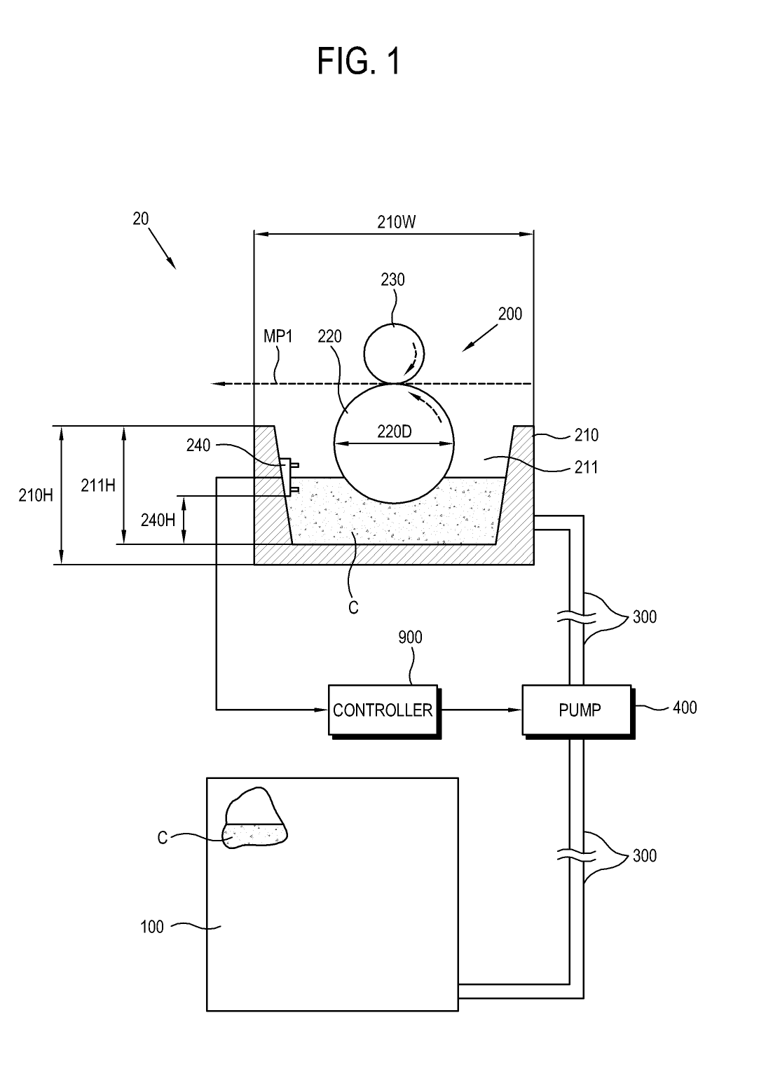

Below, a medium coating assembly 20 of an image forming apparatus according to an exemplary embodiment of the present general inventive concept will be described with reference to FIG. 1. FIG. 1 is a lateral section view of the medium coating assembly 20 of the image forming apparatus according to an exemplary embodiment of the present general inventive concept.

As shown in FIG. 1, the medium coating assembly 20 in an exemplary embodiment may improve definition of an image formed on a print medium and prevent the print medium from curling by coating the print medium fed from a medium feeding unit (not shown) with a previously designated coating liquid C in a previous stage. Here, the chemical composites and properties of the coating liquid C may be varied while realizing the present general inventive concept. In consideration of a coating efficiency to the print medium, the coating liquid C may be provided in the form of fluid.

The medium coating assembly 20 may include a container 100 to store the coating liquid C, a coating unit 200 to coat the print medium with the coating liquid C, a channel 300 formed between the container 100 and the coating unit 200, a pump 400 to make the coating liquid C run through the channel 300, and a controller 900 to drive the pump 400 to supply or recover the coating liquid C through the channel 300 according to whether or not an image is formed on the print medium.

Thus, the supply and recovery of the coating liquid C can be achieved through one channel 300.

Below, sub-elements of the medium coating assembly 20 will be described.

The container 100 may store the coating liquid C to be supplied to the coating unit 200 and the coating liquid C recovered from the coating unit 200. Although an internal configuration is not required, the container 100 may store the coating liquid C without distinguishing between the coating liquid C to be supplied and the recovered coating liquid C, and thus may use the recovered coating liquid C at the next supply of the coating liquid to the coating unit 200.

The supplying channel 210 may include a supplying channel liquid housing 211 where the coating liquid supplied from the container 100 is housed. Also, as illustrated in FIG. 1, the height and width of the supplying channel 210 are indicated via 210H and 210W, respectively. Further, 220D indicates the diameter of the coating roller 220.

There is no limit to the shape, material, color, etc. of the container 100, but the inside of the container 100, where the coating liquid C is stored, may be sealed airtight against the outside except the channel 300 through which the coating liquid C runs. Thus, it is possible to prevent the coating liquid C from being contaminated by dust, a mote, or the like from the outside and to prevent the amount of the coating liquid C from decreasing via evaporation. Further, the container 100 may have a heat-resisting configuration to prevent the chemical composites of the coating liquid C from being changed by heat generated in the image forming apparatus.

The coating unit 200 coats the print medium with the coating liquid C supplied from the container 100. To this end, the coating unit 200 may include a supplying channel 210 accommodating the coating liquid C supplied through the channel 300, and a coating member 220 receiving the coating liquid C accommodated in the supplying channel 210 and applying it to the print medium. Although the structure and the shape of the coating member 220 is not limited, a coating roller 220 is used as the coating member 220 in this exemplary embodiment.

The coating unit 200 may include an auxiliary roller 230 rotating correspondingly to the coating roller 220 and moving the print medium along a preset moving path MP1, and a level sensor 240 sensing a level of the coating liquid C accommodated in the supplying channel 210.

The supplying channel 210 may be placed under the coating roller 220 and extend in parallel with the coating roller 220. The supplying channel 210 may be formed with an accommodating space in which the coating liquid C is accommodated, and has an opened top opposite to the coating roller 220 so that the accommodated coating liquid C can be supplied to the coating roller 220.

The supplying channel 210 may connect with the channel 300 at one side, so that the coating liquid C supplied from the container 100 through the channel 300 can be accommodated and the coating liquid C accommodated in the supplying channel 210 can be recovered to the container 100 through the channel 300.

The top of the supplying channel 210 may be opened so that a partial periphery of the coating roller 220 can meet the coating liquid C. However, there is no need of a sealing structure for airtightly sealing up the supplying channel 210 and the coating roller 220, which will be described later.

The coating roller 220 may extend transversely to the moving path MP1 of the print medium and rotate while coming into contact with the print medium moved along the moving path MP1. The coating roller 220 may be arranged so that a part of the periphery thereof, i.e., a lower region in the extending direction of FIG. 1 can come into contact with the coating liquid C accommodated in the supplying channel 210. While rotating, the coating roller 220 can apply the coating liquid C from the supplying channel 210 to the print medium, thereby performing the coating.

Further, the distance from the lowest point within the supplying channel liquid housing 211 to the level sensor 240 is referenced via 240H in FIG. 1. Also, the depth of the supplying channel liquid housing 211 is referenced via 211H in FIG. 1.

Although a relative arrangement between the coating roller 220 and the supplying channel 210 is not limited, the coating roller 220 may be arranged in the opened top of the supplying channel 210 so as not to employ an additional sealing structure between the supplying channel 210 and the coating roller 220.

Although a rotating configuration of the coating roller 220 is not limited, the coating roller 220 may engage and interlock with other rollers of the image forming apparatus through a gear (not shown). That is, the coating roller 220 may start rotating together with other rollers of the image forming apparatus when a printing job begins, and stop rotating when the printing job is completed. However, the rotating configuration of the coating roller 220 is not limited thereto, and a separate motor may be used for rotating the coating roller 220.

The level sensor 240 may be provided at an inside of the supplying channel 210 accommodating the coating liquid C, and may sense the level of the coating liquid C of the supplying channel 210. The level sensor 240 may sense whether the level of the coating liquid C is a preset level or within a preset level range. Here, a configuration and a cycle where the level sensor 240 senses the level of the coating liquid C are not limited, and various configurations may be applied thereto to achieve the foregoing operation. Also, the sensing operation of the level sensor 240 may be variously performed in real time, in a preset cycle, in the first time of the printing job, etc., which may change control of the controller 900.

The channel 300 may be placed so that the coating liquid C can flow between the container 100 and the supplying channel 210. FIG. 1 illustrates one channel 300 for clarity of description, but not limited thereto. Alternatively, a plurality of channels 300 may be provided as long as they are not distinguished into a channel to supply the coating liquid C to the supplying channel 210 and a channel to recover the coating liquid C from the supplying channel 210 to the container 100. In this present general inventive concept, the supply and recovery of the coating liquid C may be achieved through one channel 300.

The channel 300 may be achieved by a static pipe or a flexible tube, but not limited thereto and may have various configurations.

The pump 400 may make the coating liquid C run through the channel 300. That is, under the control of the controller 900, the pump 400 may supply the coating liquid C from the container 100 to the supplying channel 210 and recover the coating liquid C from the supplying channel 210 to the container 100. To this end, the pump 400 can be driven forward and backward. For example, the pump 400 may supply the coating liquid C when forward driven, but recover the coating liquid C when backward driven. For convenience, the terms of “forward” and “backward” are used just for distinguishing between operations of the pump 400, which do not limit the scope of the present general inventive concept.

With respect to the plurality of channels 300, the pump 400 may also operate in the same manner. Even through there are plural channels 300, the pump 400 may not perform individual operations according to the respective channels 300, but may perform one operation throughout every channel 300. That is, the pump 400 may supply the coating liquid C through all channels 300 when driven forward, but recovers the coating liquid C through all channels 300 when driven backward.

The controller 900 may selectively drive the pump 400 according to whether an image forming unit (not shown) forms an image, i.e., whether the printing job is performed. Also, the controller 900 may control the pump 400 to be driven according to sensing results of the level sensor 240. Below, the control of the controller 900 will be described according to processes of the printing job. In an initial stage during which the printing job is not performed, the supplying channel 210 may be empty without the coating liquid C, and the coating liquid C may be accommodated in the container 100.

When the printing job begins, the image forming apparatus may start operating general components, for example, the coating roller 200 starts rotating. When receiving a printing start command, the controller 900 may drive the pump 400 to make the coating liquid C be supplied from the container 100 to the supplying channel 210 via the channel 300.

The coating liquid C may run through the channel 300 and may then be accommodated in the supplying channel 210 as the pump 400 operates, and the level sensor 240 may sense the level of the coating liquid C accommodated in the supplying channel 210. Further, the level sensor 240 may sense that the level of the coating liquid C in the supplying channel 210 is beyond a preset range, and transmit a notification of the level of the coating liquid C to the controller 900. Here, the preset range is not a limited range but a range in which the coating roller 220 can receive a proper amount of coating liquid C from the supplying channel 210. Thus, the preset range may vary depending on diverse factors such as configurations, environments, etc. of the image forming apparatus.

The controller 900 may control the pump 400 to stop operating according to the sensing results of the level sensor 240, thereby preventing the coating liquid C from being excessively accommodated in the supplying channel 210.

During the printing job, the coating roller 220 may apply the coating liquid C from the supplying channel 210 to the print medium, and thus the level of the coating liquid C may get lower in the supplying channel 210. The level sensor 240 may sense the level of the coating liquid C in real time or in a cycle, and transmit the sensing results to the controller 900 when sensing that the level of the coating liquid C drops below the preset range.

Thus, the controller 900 may determine that the amount of coating liquid C in the supplying channel 210 is less than the proper amount, and drive the pump 400 so that the level of the coating liquid C in the supplying channel 210 is within the preset range. The controller 900 may perform the foregoing processes continuously, so that the coating for the printing medium can be continuously performed during the printing job.

When the printing job is completed, the coating roller 220 may stop rotating and the coating for the print medium is not performed any more, and therefore there is no need of accommodating the supplying channel 210 in the coating liquid C. Thus, the controller 900 may drive the pump 400 to recover the coating liquid C remaining in the supplying channel 210 to the container 100 via the channel 300.

Like this, while the printing job is not performed, the coating liquid C in the supplying channel 210 can be recovered and stored in the container 100, thus preventing the coating liquid C from evaporating and being contaminated.

Further, the supply and the recovery of the coating liquid C can be performed through one channel 300, so that a simple structure of supplying and recovering the coating liquid C can be achieved.

In an exemplary embodiment of the present general inventive concept, the level sensor 240 may sense the level of the coating liquid C in real time or in a cycle, but not limited thereto. Alternatively, the sensing of the level sensor 240 may be performed only when the coating liquid C is supplied at the first time to the supplying channel 210 when the printing job begins. In this case, the controller 900 may count the number of printing times of the print media or the number of sheets of the coated print medium, and drive the pump 400 for a preset time at every preset counting number to thereby adjust the level of the coating liquid C.

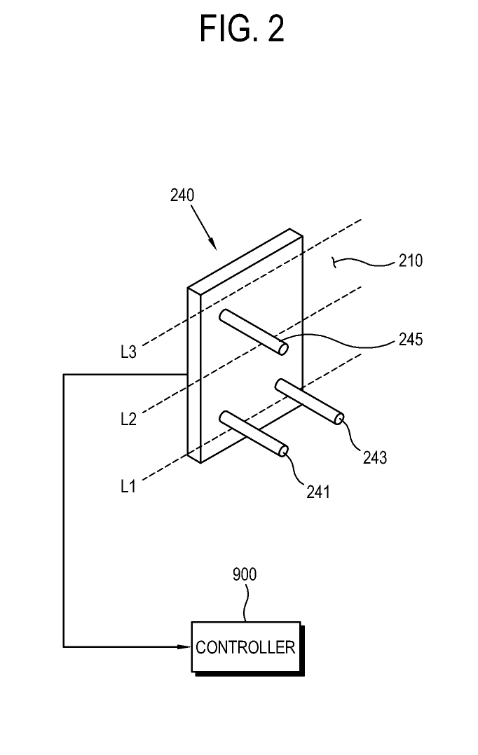

Meanwhile, the configuration of the level sensor 240 will be described with reference to FIG. 2. FIG. 2 is a perspective view of the level sensor 240 in the medium coating assembly of FIG. 1. The following configuration of the level sensor 240 is an example which does not limit the scope of the present general inventive concept.

The level sensor 240 may be mounted to an inner wall of the supplying channel 210 accommodating the coating liquid C. The level sensor 240 may include three protruding pins 241, 243, and 245. A first pin 241 and a second pin 243 may be level with each other, but a third pin 245 may be placed above the first and second pins 241 and 243 by a predetermined level.

Although it is not illustrated, the level sensor 240 may include a voltage output circuit connected to each pin 241, 243, and 245, and the voltage output circuit may output different voltages to the controller 900 according to conductive conditions between the pins 241, 243, and 245.

For example, the coating liquid C may have levels of L1, L2, and L3.

If the coating liquid C has the level of L1, the level of the coating liquid C may be positioned below all the pins 241, 243, and 245. In this case, all the pins 241, 243, and 245 are not electrically connected to one another.

If the coating liquid C has the level of L2, the level of the coating liquid C may be positioned above the first pin 241 and the second pin 243, but positioned below the third pin 245. In this case, the first pin 241 and the second pin 243 are electrically connected to each other through the coating liquid C, but the third pin 245 may be electrically connected to neither the first pin 241 nor the second pin 243.

If the coating liquid C has the level of L3, the level of the coating liquid C may be positioned above all the pins 241, 243, and 245.

Thus, the number of pins 241, 243, and 245 to be electrically connected is varied depending on the levels L1, L2, and L3 of the coating liquid C, so that the level sensor 240 can output different voltages. Accordingly, the controller 900 can determine the sensing results of the level sensor 240 on the basis of the voltage output from the level sensor 240.

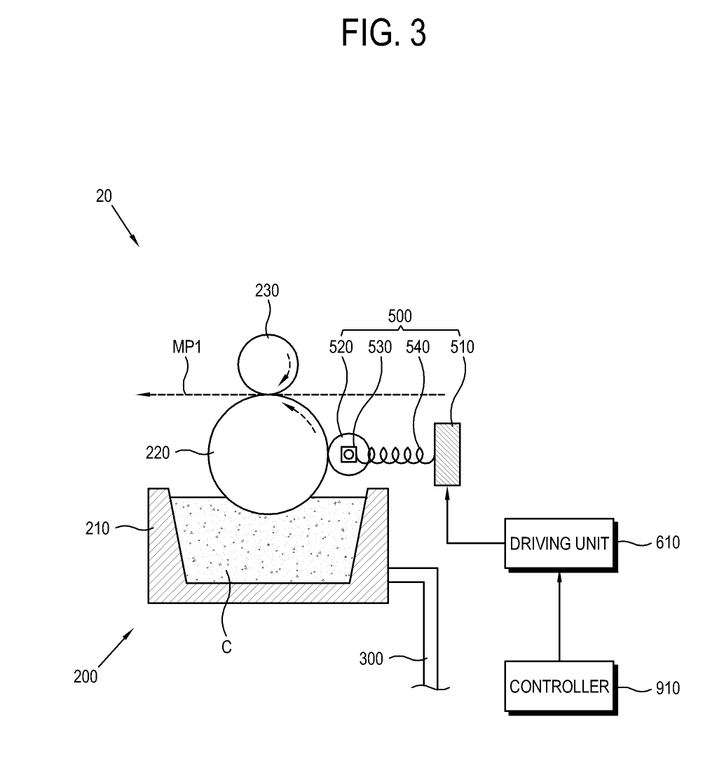

Below, the medium coating assembly 20 according to another exemplary embodiment of the present general inventive concept will be described with reference to FIG. 3. FIG. 3 is a lateral section view of the medium coating assembly 20 of an image forming apparatus according to another embodiment of the present general inventive concept.

As illustrated in FIG. 3, the medium coating assembly 20 in the exemplary embodiment of the present general inventive concept may include the coating unit 200 provided with the coating roller 220 coming into contact with and applying the coating liquid C to the print medium, a coating liquid regulating unit 500 regulating the coating liquid C on the coating roller 220, and a controller 910 controlling the coating liquid regulating unit 500 to have a regulation level for the coating liquid C in response to change in a rotating speed of the coating roller 220.

Thus, even though the rotating speed of the coating roller 220 may be varied according to the kinds of print medium or the printing jobs, the coating liquid regulating unit 500 may adjust the regulation level of the coating liquid on the coating roller 220, thereby securing the coating level of each print medium uniformly regardless of the rotating speed of the coating roller 220.

The coating unit 200 may include the supplying channel 210 accommodating the coating liquid C supplied from the channel 300, the coating roller 220 coating the print medium with the coating liquid C of the supplying channel 210, and an auxiliary roller 230. These follow a previously described exemplary embodiment of the present general inventive concept, thus repetitive descriptions will be avoided.

The coating liquid regulating unit 500 may regulate the thickness of the coating liquid C on a periphery of the coating roller 220 when the coating roller 220 rotates coming into contact with the coating liquid C of the supplying channel 210, thereby adjusting the coating level of the print medium. Further, the coating liquid regulating unit 500 may uniformly spread out the coating liquid C on the periphery of the coating roller 220, thereby preventing the coating of the print medium from leaning to a local section.

The coating liquid regulating unit 500 may include a supporting frame 510 provided movably, a regulating member 520 forming a nip together with the coating roller 220, and an elastic member 540 supported by the supporting frame 510 and elastically urging the regulating member 520 against the coating roller 220.

The supporting frame 510 may mount to a main body frame (not illustrated) of the image forming apparatus, and movable between predetermined positions under control of the controller 910. To this end, there may be provided a driving unit 610 operating under the control of the controller 910 and moving the supporting frame 510. The driving unit 610 may be achieved by various configurations such as a motor, a gear, etc.

The supporting frame 510 may be provided not to be separated from a current position by a force other than the driving unit 610 controlled by the controller 910, e.g., an elastic force of the elastic member 540. Thus, a regulating pressure can be usable with the nip between the coating roller 220 and the regulating member 520.

The regulating member 520 may be disposed in parallel with the coating roller 220, and forms the nip together with the coating roller 220, thereby regulating the coating liquid C on the periphery of the coating roller 220. The regulating member 520 may have any shape, e.g., a cylindrical shape, a blade shape, etc. without limitation as long as it can form the nip together with the coating roller 220. In this embodiment, the regulating member 520 is shaped like a cylinder, and thus it is possible to relatively decrease the abrasion on the surface of the coating roller 220 even though the coating roller 220 rotates.

The regulating member 520 may be fastened at opposite end parts thereof like this exemplary embodiment of the present general inventive concept or be rotatably supported, which may vary without departing from the scope of the present general inventive concept.

At the end part of the regulating member 510 may be provided a supporting member 530 to support the regulating member 520, and the elastic member 540 to elastically urge the supporting member 530 toward the regulating member 520, thereby generating a contact surface pressure in the nip.

The elastic member 540 has a first end part coupled to the supporting frame 510 and a second end part coupled to the supporting member 530, thereby pressing the regulating member 520 to the coating roller 220. Thus, the pressure may be usable with the nip between the regulating member 520 and the coating roller 220, and the regulating level for the coating liquid C in the nip is determined according to the pressure.

For example, the elastic member 540 can be achieved without limitation by a coil spring, a flat spring, rubber, etc. as long as it can form an elastic bias.

The controller 910 may control the driving unit 610 to drive the supporting frame 510 to vary in position in response to the rotating speed of the coating roller 220 during the printing job. In this exemplary embodiment of the present general inventive concept, the coating roller 220 may rotate while interlocking with other rollers of the image forming apparatus, so that the controller 910 can determine the change in the rotating speed of the coating roller 220 according to a printing job command. However, a separate sensor (not illustrated) may be provided to sense the rotating speed of the coating roller 220.

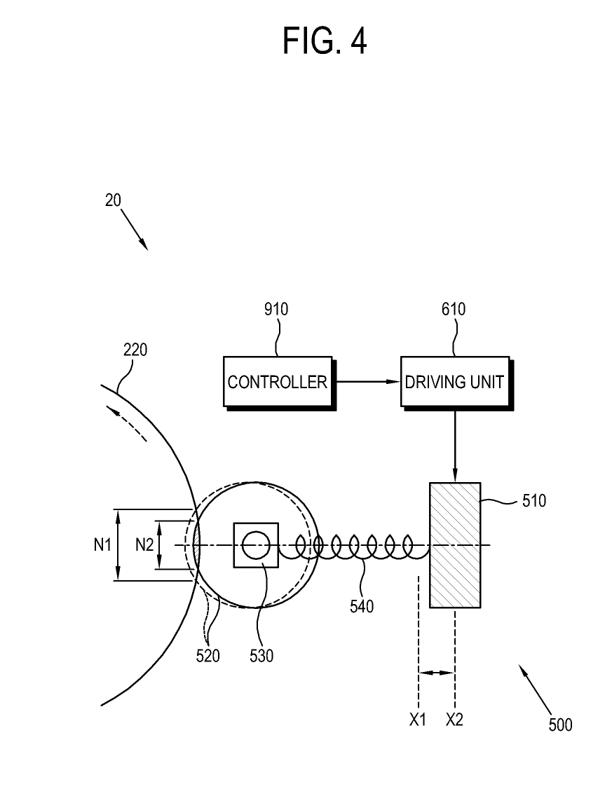

In another exemplary embodiment of the present general inventive concept, a method that the coating liquid regulating unit 500 regulates the coating liquid C of the coating roller 220 will be described below with reference to FIG. 4. FIG. 4 is a lateral section view illustrating an example of controlling the coating liquid regulation corresponding to the rotating speed of the coating roller 220 in the medium coating assembly 20 of FIG. 3.

As illustrated in FIG. 4, the rotating speed of the coating roller 220 may vary depending on a printing mode. For example, if the printing mode corresponds to a high speed, the coating roller 220 may rotate at a speed of S1. On the other hand, if the printing mode corresponds to a low speed, the coating roller 220 may rotate at a speed of S2, where S1>S2. In this exemplary embodiment, two speeds will be described, but are not limited thereto. Alternatively, three or more printing modes may be possible.

If the coating liquid regulation of the coating liquid regulating unit 500 is not adjusted to correspond to the change in the rotating speed of the coating roller 220, the amount of coating liquid C usable with the print medium at the speed S1 may be greater than that at the speed S2. The coating liquid regulating unit 500 in this exemplary embodiment of the present general inventive concept may adjust the pressures at the nips N1 and N2 in response to the rotating speeds S1 and S2 of the coating roller 220, thereby uniforming the amount of the coating liquid C usable with the print medium.

When it is determined that the coating roller 220 rotates at the speed S1, the controller 910 may control the driving unit 610 to move the supporting frame 510 to a position X1. As the supporting frame 510 moves to the position X1, the elastic bias usable with the regulating member 520 may relatively increase, and the width of the nip N1 may also relatively increase, thereby increasing the pressure applied to the nip N1. Thus, the amount of the coating liquid C regulated by the nip N1 increases, so that the amount of the coating liquid C can be prevented from being excessively applied from the coating roller 220 to the print medium.

Meanwhile, if it is determined that the rotating speed of the coating roller 200 changes to S2, the controller 910 may control the driving unit 610 to move the supporting frame 510 to a position X2. As the supporting frame 510 moves from the position X1 to the position X2, the elastic bias usable with the regulating member 520 may relatively decrease as compared with the case that the coating roller 220 rotates at the speed S1. Further, the width of the nip N1 may also relatively decrease to N2, thereby relatively decreasing the pressure applied to the nip as compared with the case of N1. Thus, the amount of the coating liquid C regulated by the nip N2 decreases as compared with that regulated by the nip N1, so that the amount of the coating liquid C applied from the coating roller 220 to the print medium can be equal to that of the case N1

Thus, the controller 910 may control the supporting frame 510 to approach the coating roller 220 by a preset distance as the rotating speed of the coating roller 220 becomes faster, and may control the supporting frame to become apart from the coating roller 220 by a preset distance as the rotating speed of the coating roller 220 becomes slower, thereby adjusting the pressure applied to the nip to regulate the coating liquid C on the coating roller 220 in response to the change in the rotating speed.

Accordingly, the coating level of the print medium can be uniformized regardless of the change in the rotating speed.

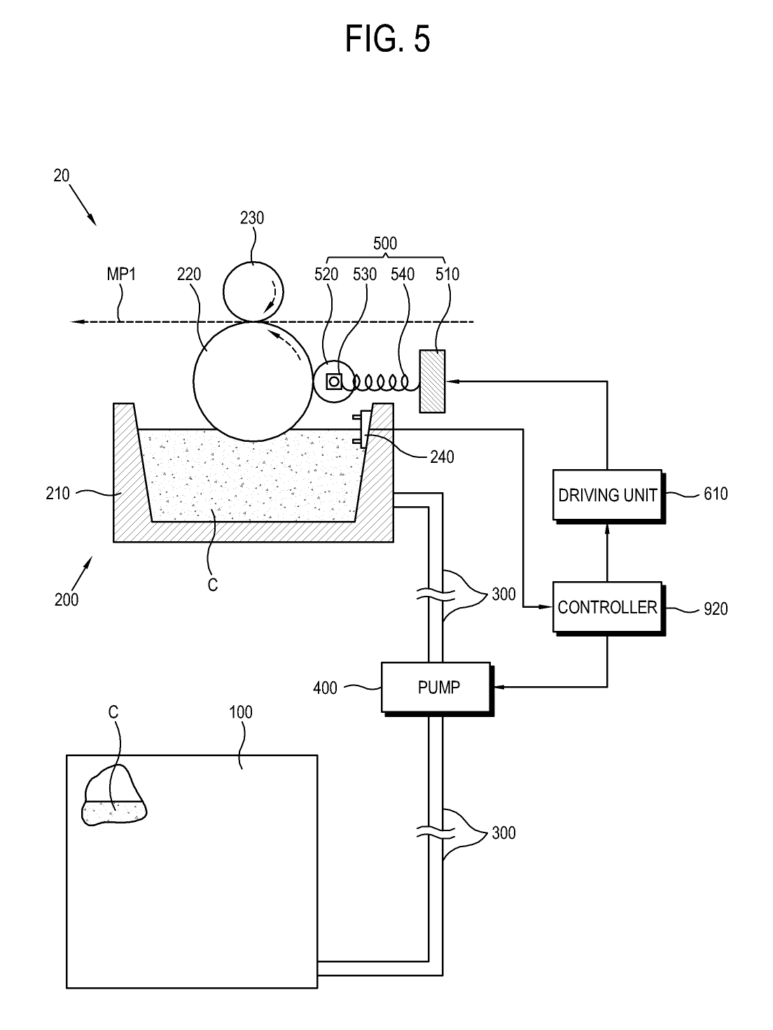

As described above, the exemplary embodiments of the present general inventive concept are described with reference to the accompanying drawings, respectively, but are not limited thereto. Below, another exemplary embodiment where other exemplary embodiments are combined will be described with reference to FIG. 5. FIG. 5 is a lateral section view of the medium coating assembly 20 of an image forming apparatus according to another exemplary embodiment of the present general inventive concept.

As illustrated in FIG. 5, the medium coating assembly 20 in another exemplary embodiment of the present general inventive concept may include the container 100, the coating unit 200, the channel 300, the pump 400 and the coating liquid regulating unit 500. Each element and its sub elements of the medium coating assembly 20 follow those of other exemplary embodiments previously described, and thus repetitive descriptions thereof will be avoided. Exceptionally, a controller 920 may not only selectively drive the pump 400 according to the sensing results of the level sensor 240 but also control the driving unit 610 to move the supporting frame 510.

Below, the control of the controller 920 during the printing job will be described.

When receiving a printing job start command, the controller 920 may drive the pump 400 to make the coating liquid C be supplied from the container 100 to the supplying channel 210 via the channel 300. The coating liquid C running through the channel 300 may be accommodated in the supplying channel 210, and the level sensor 240 may sense the level of the coating liquid C and transmit sensing results to the controller 920. On the basis of the sensing results, the controller 920 may adjust the level of the coating liquid C in the supplying channel 210 to a preset proper level.

The controller 920 may control the driving unit 610 to adjust the position of the supporting frame 510 according to the rotating speed of the coating roller 220 corresponding to the printing job of the first print medium. Then, if it is determined that the rotating speed of the coating roller 220 changes, the controller 920 may control the supporting frame 510 to move to a preset position, thereby adjusting the pressure in the nip between the coating roller 220 and the regulating member 520. Thus, the uniform amount of the coating liquid C may be applied from the coating roller 220 to the print medium.

As the coating operations for the print medium are repeated, the level of the coating liquid C in the supplying channel 210 may become lower than the preset range. When receiving such results from the level sensor 240, the controller 920 may drive the pump 400 to supply the coating liquid C to the supplying channel 210 so that the level of the coating liquid C can be within the preset range.

When the printing job is completed, the controller 920 may drive the pump 400 to recover the coating liquid C remaining in the supplying channel 210 into the container 100 via the channel 300. Also, the controller 920 may move the supporting frame 510 so that the coating roller 220 and the regulating member 520 can become apart from each other while no printing job is performed. Thus, the coating roller 220 and the regulating member 520 may be prevented from abrasion, deformation, etc.

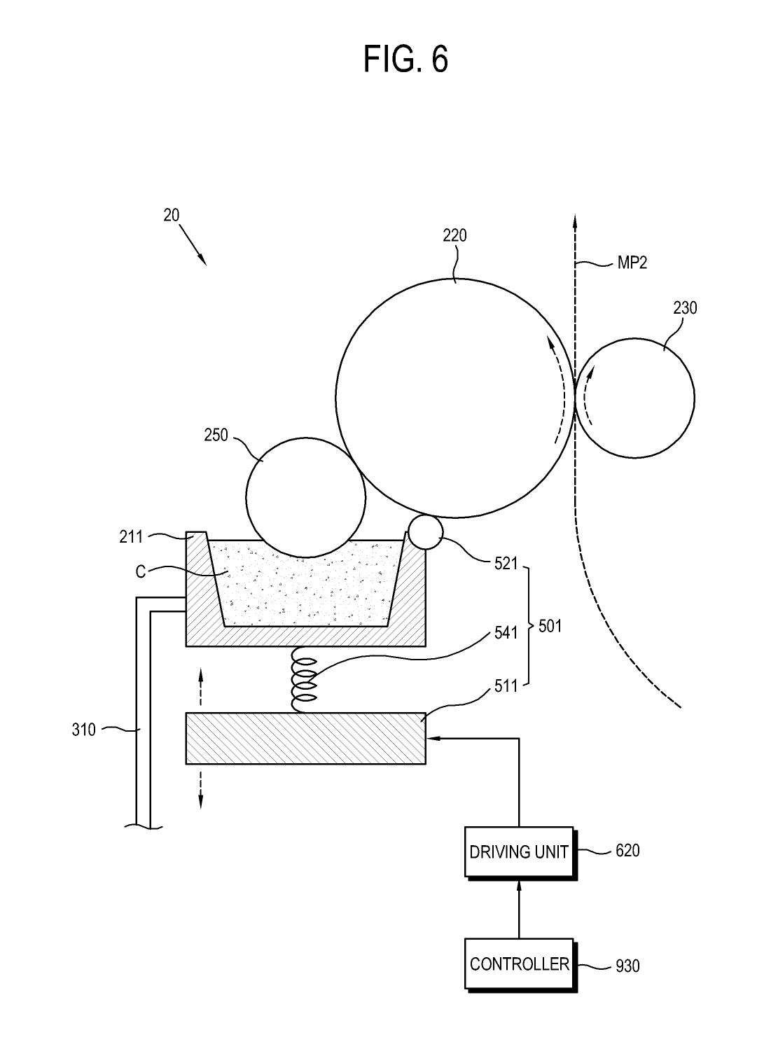

Meanwhile, a coating liquid regulating unit 501 may have different configurations from those of other exemplary embodiments of the present general inventive concept, which will be described as another exemplary embodiment with reference to FIG. 6. FIG. 6 is a lateral section view of the medium coating assembly 20 according to another exemplary embodiment of the present general inventive concept.

As illustrated in FIG. 6, the medium coating assembly 20 in the exemplary embodiment of the present general inventive concept may include a supplying channel 211 to accommodate the coating liquid received via a channel 310, a coating roller 220 to apply the coating liquid C on to the print medium moved along a moving path MP2, and an auxiliary roller 230, and a coating liquid regulating unit 501. Here, there may be provided a supplying roller 250 to supply the coating liquid C accommodated in the supplying channel 211 to the coating roller 220.

Here, the moving path MP2 of the print medium heads upward, which is different from the exemplary embodiment of FIG. 3. In the exemplary embodiment of FIG. 3, the present general inventive concept can be achieved variously according to the direction of the moving path MP2.

The coating liquid regulating unit 501 may include a supporting frame 511 provided movably, a regulating member 521 coupled to one side of the supplying channel 211, and an elastic member 541 supported by the supporting frame 511 and elastically urging the regulating member 521 against the coating roller 220.

The supporting frame 511 may be disposed under the supplying channel 211, and movable up and down by the driving unit 620 under control of a controller 930.

The regulating member 521 may be placed outside the supplying channel 211, where the coating liquid C can be accommodated without interference, and disposed in parallel with the lengthwise direction of the supplying channel 211 and the coating roller 220. The regulating member 521 may form a nip together with the coating roller 220, and regulate the coating liquid C of the coating roller 220 through the nip.

The elastic member 541 may be interposed between the supporting frame 511 and the supplying channel 211, and may elastically urge the supplying channel 211 toward the coating roller 220. Here, the regulating member 521 may couple to one side of the supplying channel 211, so that the elasticity of the elastic member 541 acts as the contact surface pressure in the nip between the coating roller 220 and the regulating member 521.

The controller 930 may control the driving unit 620 to drive the supporting frame 511 to approach or become apart from the coating roller 220 in correspondence to the rotating speed of the coating roller 220. Thus, the coating liquid regulation of the coating roller 220 is varied depending on the change in the rotating speed of the coating roller 220, so that the uniform amount of the coating liquid C can be usable with the print medium. This follows a previously described exemplary embodiment of the present general inventive concept, thus repetitive descriptions thereof will be avoided.

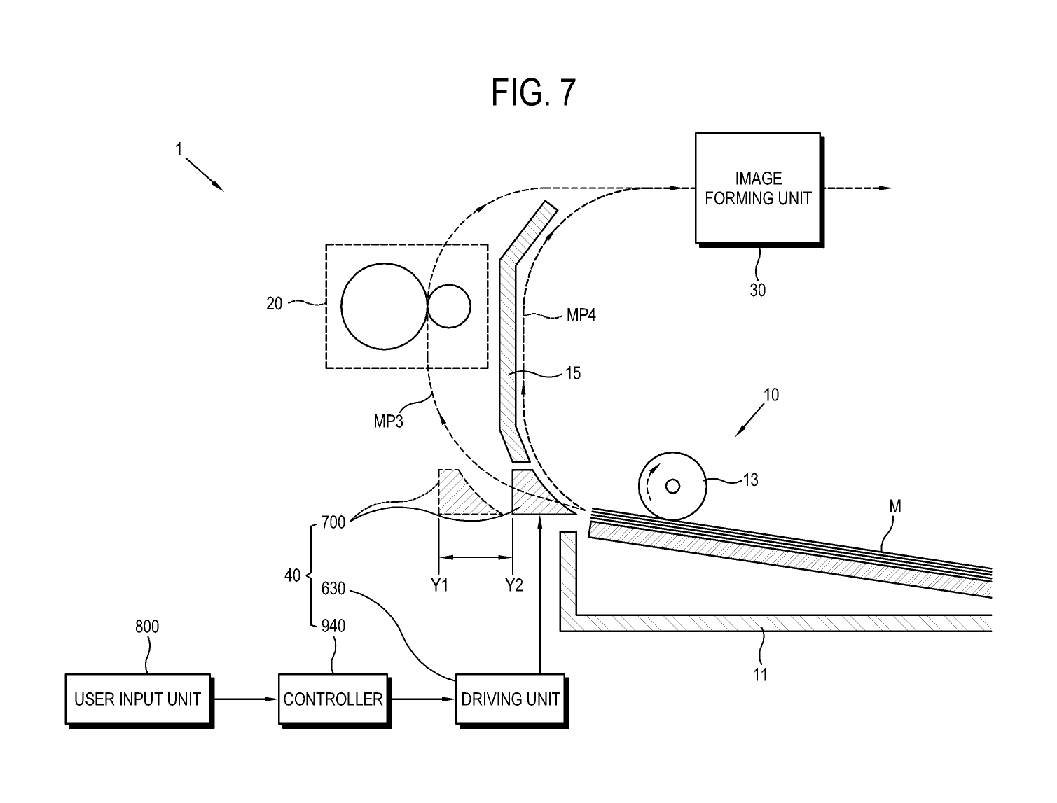

Below, an image forming apparatus 1 according to another exemplary embodiment of the present general inventive concept will be described with reference to FIG. 7. FIG. 7 is a lateral section view showing a partial schematic configuration of the image forming apparatus 1 according to another exemplary embodiment of the present general inventive concept.

As illustrated in FIG. 7, the image forming apparatus 1 according to another exemplary embodiment of the present general inventive concept may include a medium feeding unit 10 supplying a print medium M, a medium coating assembly 20 coating the print medium M with the coating liquid, and an image forming unit 30 forming an image on the print medium M.

The medium feeding unit 10 may include a loading cassette 11 where the print medium M is loaded, and a pickup roller 13 to pick up the print medium M loaded in the loading cassette 11. When a printing job begins, the pickup roller 13 may pick up the print medium M one by one and supply it to the image forming unit 30.

The medium coating assembly 20 follows those of the foregoing exemplary embodiments of the present general inventive concept, and repetitive descriptions thereof will be avoided.

The image forming unit 30 may eject ink on the print medium M and form an image. The image forming unit 30 may include an array type where a cartridge to eject the ink is extended throughout a transverse width of the print medium M, a shuttle type where a cartridge ejects the ink while moving straightly along the transverse width of the print medium M, etc.

Here, the print medium M supplied from the medium feeding unit 10 to the image forming unit 30 may have two moving paths MP3 and MP4. One moving path MP3 may pass through the medium coating assembly 20, but the other moving path MP4 may bypass the medium coating assembly 20. Each path may include one or more transporting rollers (not illustrated) to transport the print medium M.

In this exemplary embodiment of the present general inventive concept, the image forming apparatus 1 may include a path selecting unit 40 to guide the print medium M to be transported from the medium feeding unit 10 selectively along one of the two moving paths MP3 and MP4, and a user input unit 800 to allow a user to select one of the two moving paths MP3 and MP4.

Additionally, there may be provided a path division frame 15 to physically separate the moving paths MP3 and MP4 from each other, so that the print medium M being transported along one moving path can be prevented from being transmitted to the other moving path.

Thus, a user may select the print medium M to pass through the medium coating assembly 20 or not to pass through the medium coating assembly 20, thereby selecting whether to coat the print medium M in the medium coating assembly 20. That is, even though a common print medium M having a need of the coating and a special print medium M having no need of the coating may be loaded to one loading cassette 11, the common print medium M undergoes the coating but the special print medium M does not undergo the coating.

The user input unit 800 may transmit a control command of a user to a controller 940. In this exemplary embodiment of the present general inventive concept, the user input unit 800 may be achieved by a control panel (not illustrated) provided on an external side of the image forming apparatus 1, a host (not illustrated) connected to the image forming apparatus 1 locally or by a network, etc.

Through the user input unit 800, a user may use various methods to select the moving paths MP3 and MP4 for the print medium M. For example, a user may select one of the moving paths MP3 and MP4, or designate the print medium M as the kind of that needs the coating.

The path selecting unit 40 may include a guide 700 to guide the print medium M to be selectively transported along the moving path MP3 or MP4, a driving unit 530 to move the guide 700, and the controller 940 to control the driving unit 630 to move the guide 700.

The guide 700 may be movably mounted to the main body frame (not illustrated) of the image forming apparatus 1. The guide 700 may move between a position Y1 and a position Y2. Here, the position Y1 is to guide the print medium M to the moving path MP3 where the print medium M picked up by the pickup roller 13 is transported to the medium coating assembly 20. On the other hand, the position Y2 may guide the print medium MP4 where the print medium M is directly transported to the image forming unit 30 without passing through the medium coating assembly 20.

When a printing job begins, the controller 940 may ascertain whether the moving path for the print medium M is selected through the user input unit 800.

If the print medium M is selected to be transported along the moving path MP3, i.e., to undergo the coating, the controller 940 may controls the driving unit 630 to drive the guide 700 to move to the position Y1. When a printing job begins, the print medium M picked up by the pickup roller 13 may move along the moving path MP3 and undergo the coating in the medium coating assembly 20, and then the image forming unit 30 may form an image on the print medium M.

On the other hand, if the print medium M is selected to be transported along the moving path MP4, i.e., not to undergo the coating, the controller 940 may control the driving unit 630 to drive the guide 700 to move to the position Y2. When a printing job begins, the print medium M picked up by the pickup roller 13 may be prevented from entering the moving path MP3 by the guide 700 and transported along the moving path MP4. Thus, the print medium M transported along the moving path MP4 may be sent to the image forming unit 30 without passing through the medium coating assembly 20.

If it is ascertained that the moving path of the print medium M is not selected through the user input unit 800, the controller 940 may control the print medium M to be transported along a path designated as default between the moving paths MP3 and MP4.

Thus, a path to send the print medium M to the medium coating assembly 20 and a path not to send the print medium M to the medium coating assembly 20 may be set up, respectively, and the guide 700 may selectively guide the print medium M to the respectively paths, thereby selecting the coating for the print medium M.

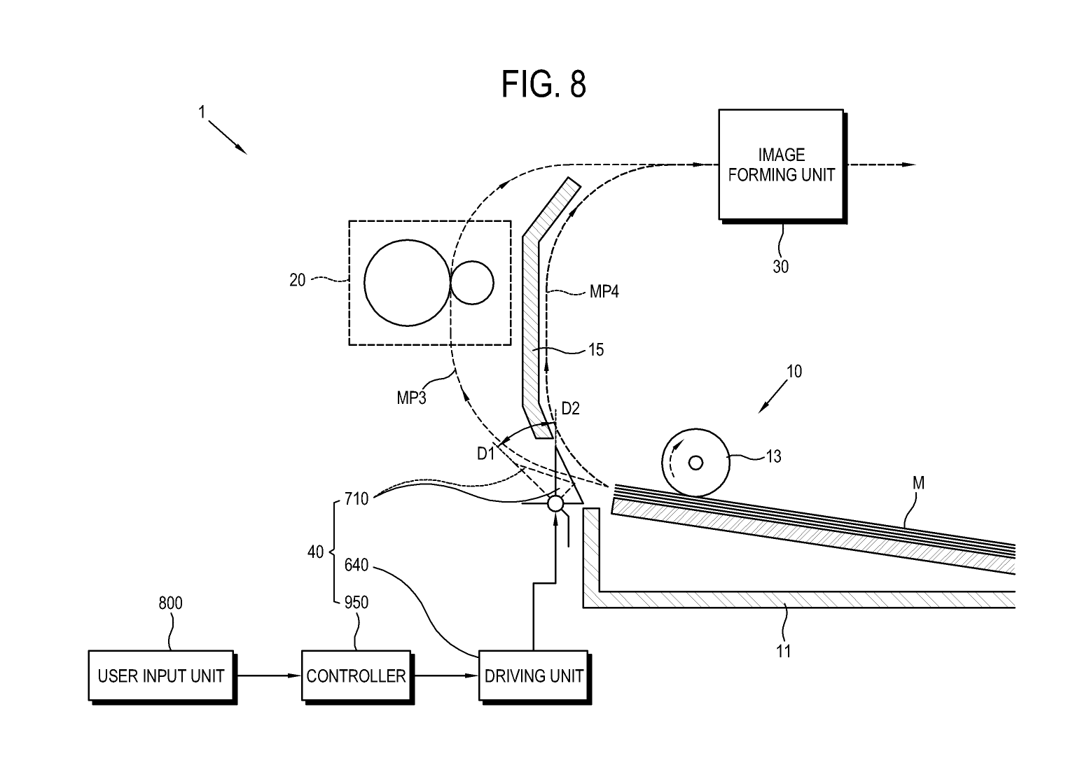

In the meantime, the configuration of the guide 700 to selectively guide the print medium M to a plurality of moving paths is not limited to that according to another exemplary embodiment of the present general inventive concept. Thus, a guide 710 having a different configuration from that of other exemplary embodiments will be described as another exemplary embodiment of the present general inventive concept with reference to FIG. 8. FIG. 8 is a lateral section view showing a partial schematic configuration of the image forming apparatus 1 according to another exemplary embodiment of the present general inventive concept.

Here, the same elements as those of previously described exemplary embodiments will be avoided to minimize repetitive descriptions.

As illustrated in FIG. 8, the path selecting unit 40 of the image forming apparatus 1 according to another exemplary embodiment of the present general invention may include a guide 710 to selectively guide the print medium M from the medium feeding unit 10 to one of the moving paths MP3 and MP4.

The guide 710 may be rotatably coupled to the main body frame (not illustrated) of the image forming apparatus 1, and may rotate between positions D1 and D2 by operation of the driving unit 640 under control of the controller 950.

Here, the position D1 of the guide 710 may guide the print medium M picked up by the pickup roller 13 to be transported along the moving path MP3 passing through the medium coating assembly 20. On the other hand, the position D2 may guide the print medium M to be transported along the moving path MP4 bypassing the medium coating assembly 20.

The controller 950 may control the driving unit 640 to rotate the guide 710 between the positions D1 and D2 according to an input of the user input unit 800. Thus, the print medium M may be selectively guided to the respective paths, thus selected to undergo or not to undergo the coating.

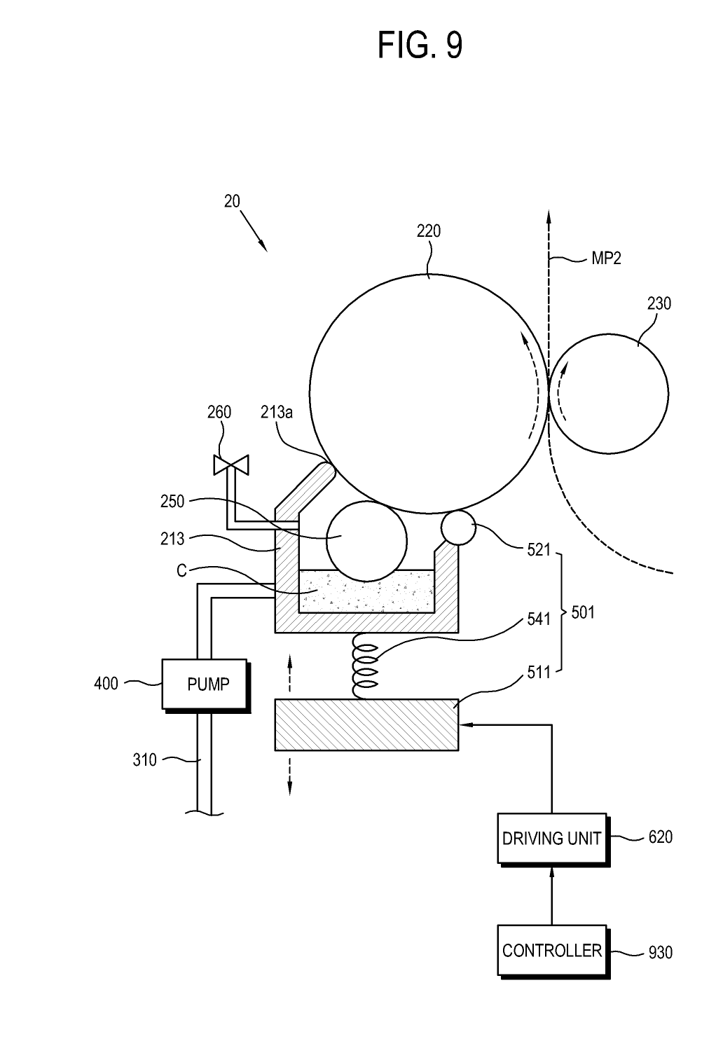

In the foregoing exemplary embodiments of the present general inventive concept, the top of the supplying channel is opened, so that the coating liquid may be contaminated during a printing job. Thus, according to another exemplary embodiment of the present general inventive concept, a configuration to prevent the coating liquid from being contaminated will be described with reference to FIG. 9.

FIG. 9 is a lateral section view of a medium coating assembly 20 in an image forming apparatus according to another exemplary embodiment of the present inventive concept. In comparison with the exemplary embodiment in FIG. 6, descriptions about substantially the same elements follow those of the exemplary embodiment in FIG. 6, thus repetitive descriptions thereof will be avoided.

As illustrated in FIG. 9, a supplying channel 213 may be formed with an accommodating part to accommodate the coating liquid C therein, and a regulating member 521 may be coupled to the outside of the supplying channel 213 to form a nip together with the coating roller 220.

Here, the supplying channel 213 and the coating roller 220 may be sealed to seal off the inside of the supplying channel 213 accommodating the coating liquid C against the outside. In FIG. 9, a right side of the supplying channel 213 is sealed with the regulating member 521, and a left side thereof is formed with a sealing part 213a to seal the supplying channel 213 against the coating roller 220, but is not limited thereto. Alternatively, if the right side of the supplying channel 213 is not sealed with the regulating member 521, the sealing part 213a may be also formed in the right side.

The sealing part 213a may be provided to minimally interfere with the rotation of the coating roller 220. To this end, various configurations may be used. The sealing part 213a may be provided separately from the supplying channel 213 and coupled to the supplying channel 213 or integrated with the supplying channel 213, or may undergo a separate surface treatment. Also, the sealing part 213a may have various shapes, materials, etc. without limiting the scope of the present general inventive concept.

As such a sealing configuration is applied between the supplying channel 213 and the coating roller 220, the coating liquid C accommodated in the supplying channel 213 can be prevented from being contaminated, evaporating, etc.

However, if the pump 400 operates in this sealed configuration, the inside of the supplying channel 213 accommodating the coating liquid C may be increased or decreased in pressure as compared with the outside. For example, if an internal pressure of the supplying channel 213 increases beyond a predetermined critical value with respect to the outside, the supplying channel 213 may be cracked.

To prevent this, an air vent 260 may be provided in one side of the supplying channel 213 and may adjust pressure change inside the supplying channel 213 in response to the operation of the pump 400.

The air vent 260 may have a valve structure to selectively open and close corresponding to the pressure change inside the supplying channel 213. With this configuration, in an initial state where the pump 400 does not operate and the pressure inside the supplying channel 213 is within a preset range, the air vent 260 may be closed to seal off the supplying channel 213.

If the pump 400 operates during a printing job, the inner pressure of the supplying channel 213 may reach beyond the preset range, therefore the air vent 260 may be opened to adjust the pressure inside the supplying channel 213. If the pressure is controlled to be within the preset range, the air vent 260 is closed again. These operations are repeated during a printing job, so that the pressure inside the supplying channel 213 can be properly maintained.

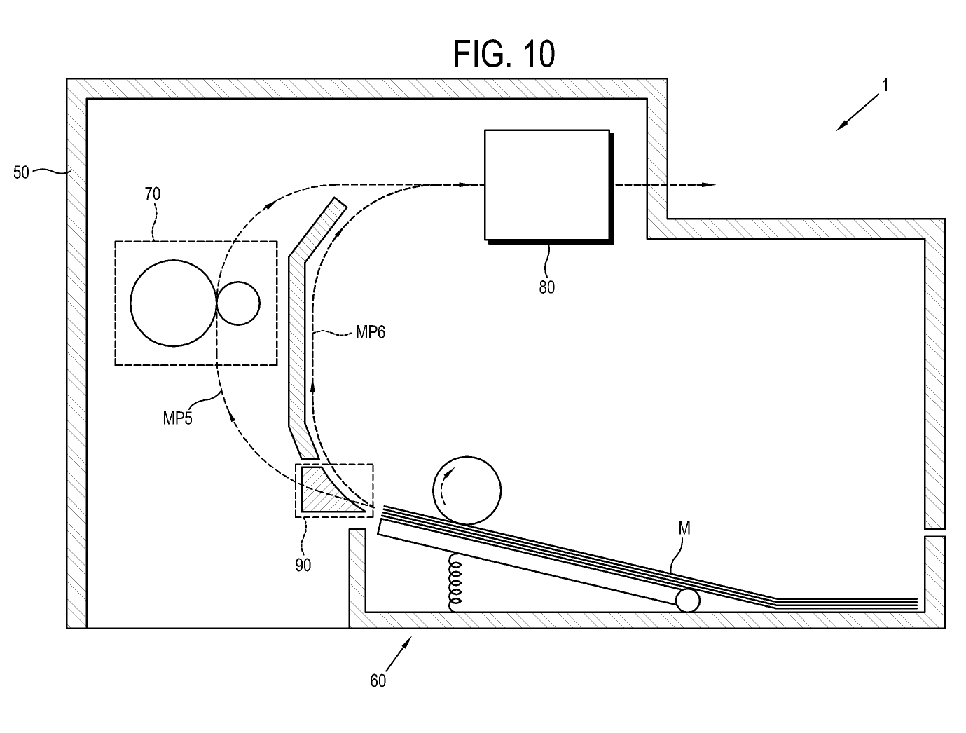

Below, an image forming apparatus 1 according to another exemplary embodiment of the present general inventive concept will be described with reference to FIG. 10. FIG. 10 is a lateral section view of a schematic configuration of the image forming apparatus 1 according to another exemplary embodiment of the present general inventive concept.

As illustrated in FIG. 10, the image forming apparatus 1 according to another exemplary embodiment of the present general inventive concept may include a main body frame 50, a medium feeding unit 60 to supply a print medium M, a medium coating assembly 70 to coat the print medium M transported from the medium feeding unit 60 via a moving path MP5, an image forming unit 80 to form an image on the print medium M, and a path selecting unit 90 to guide the print medium M to be transported along one of the moving path MP5 and a moving path MP6 bypassing the medium coating assembly 70.

The respective elements of the exemplary embodiment of the present general inventive concept is substantially the same as those of the foregoing exemplary embodiments, thus repetitive descriptions thereof will be avoided.

As described above, with respect to a supplying channel accommodating a coating liquid, supply and recovery of the coating liquid may be achieved through one channel, so that a structure to supply and recover the coating liquid can be achieved by a simple configuration without an airtight-sealing configuration.

Further, coating liquid may be recovered when a printing job is completed, so that the coating liquid can be prevented from evaporating, being contaminated, or the like while a printing job is not performed for a long time.

Also, a level sensor may be used to adjust a level of a coating liquid in a supplying channel, so that a coating level for a print medium can be secured by controlling the amount of the coating liquid supplied to a coating roller.

Further, a regulation level of a coating liquid may be regulated corresponding to change in a rotating speed of a coating roller by a coating liquid regulating unit, so that the coating level of the print medium can be uniformly secured regardless of the rotating speed of the coating roller.

Also, it is possible to control whether to send a print medium to a medium coating assembly, so that a user can select whether to apply coating to the print medium without loading the print medium into a separate loading cassette or tray.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus comprising:
a medium feeding unit to supply a print medium;
a medium coating assembly to coat the print medium with a coating liquid; and
an image forming unit to form an image on the coated print medium,
the medium coating assembly comprising:
a container to store the coating liquid;
a coating unit to coat the print medium with the coating liquid;
a channel to guide the coating liquid to move between the container and the coating unit; and
a controller to selectively control the coating liquid to be supplied from the container to the coating unit and to be recovered from the coating unit to the container through the same channel.

2. The image forming apparatus according to claim 1, further comprising:
a pump to supply or recover the coating liquid through the channel,
wherein the controller controls the pump to supply or recover the coating liquid according to whether the image forming unit forms an image.

3. The image forming apparatus according to claim 2, wherein the controller controls the pump to supply the coating liquid from the container via the channel when the image forming unit starts forming an image, and controls the pump to recover the coating liquid to the container via the channel when the image forming unit completes forming an image.

4. The image forming apparatus according to claim 2, wherein the coating unit comprises
a supplying channel to accommodate the coating liquid to be supplied through the channel; and
a coating member to receive and apply the coating liquid from the supplying channel to the print medium.

5. The image forming apparatus according to claim 4, wherein the coating unit further comprises:
a level sensor to sense a level of the coating liquid accommodated in the supplying channel.

6. The image forming apparatus according to claim 5, wherein the controller controls the pump to adjust the level of the coating liquid within a preset level range if determining that the level of the coating liquid sensed by the level sensor is beyond the preset level range.

7. The image forming apparatus according to claim 4, wherein the supplying channel and the coating member are sealed, and the coating unit further comprises:
an air vent provided in the supplying channel and adjusting pressure inside the supplying channel as the pump operates.

8. The image forming apparatus according to claim 1, wherein the medium coating assembly further comprises:
a coating liquid regulating unit to regulate the coating liquid of the coating unit, to be usable with the print medium, and
the controller controls a coating liquid regulation of the coating liquid regulating unit in response to a speed change in applying the coating liquid by the coating unit.

9. The image forming apparatus according to claim 8, wherein the coating unit comprises:
a coating roller coming into contact with the print medium and applying the coating liquid to the print medium, and
the coating liquid regulating unit regulates the coating liquid on a surface of the coating roller.

10. The image forming apparatus according to claim 9, wherein the controller controls the coating liquid regulation in response to a speed change in rotating the coating roller.

11. The image forming apparatus according to claim 9, wherein the coating liquid regulating unit comprises:
a supporting frame movably provided;
a regulating member forming a nip together with the coating roller; and
an elastic member supported by the supporting frame to elastically urge the regulating member against the coating roller and forming pressure to regulate the coating liquid in the nip.

12. The image forming apparatus according to claim 11, wherein the controller adjusts pressure in the nip formed between the coating roller and the regulating member by moving the supporting frame in response to rotating speed of the coating roller.

13. The image forming apparatus according to claim 12, wherein the controller controls the supporting frame to approach the coating roller by a preset distance as the rotating speed of the coating roller becomes faster, but to become apart from the coating roller by a preset distance as the rotating speed of the coating roller becomes slower.

14. The image forming apparatus according to claim 9, wherein the coating unit further comprises:
a supplying channel accommodating the coating liquid to be supplied to the coating roller, and
the coating liquid regulating unit comprises:
a supporting frame movably provided;
a regulating member coupled to the supplying channel and forming a nip together with the coating roller; and
an elastic member supported by the supporting frame to elastically urge the supplying channel to the coating roller and forming pressure to regulate the coating liquid in the nip.

15. The image forming apparatus according to claim 14, wherein the controller adjusts pressure in the nip formed between the coating roller and the regulating member by moving the supporting frame in response to rotating speed of the coating roller.

16. The image forming apparatus according to claim 15, wherein the controller controls the supporting frame to approach the coating roller by a preset distance as the rotating speed of the coating roller becomes faster, but also to move away from the coating roller by a preset distance as the rotating speed of the coating roller becomes slower.

17. The image forming apparatus according to claim 14, wherein the supplying channel and the coating roller are sealed, and
the coating unit further comprises:
an air vent provided in the supplying channel and adjusting pressure inside the supplying channel as the pump operates.

18. The image forming apparatus according to claim 1, further comprising:
a path selecting unit to guide the print medium of the medium feeding unit to be transported along a first path or a second path.

19. The image forming apparatus according to claim 18, wherein the path selecting unit comprises:
a guide movable between a first position where the print medium is guided to be transported along the first path and a second position where the print medium is guided to be transported along the second path.

20. The image forming apparatus according to claim 19, further comprising:
a user input unit to select one of the first path and the second path,
wherein the controller controls the guide to move to one of the first position and the second position as selected through the user input unit.
